(19) United States
(12) Patent Application Publication
(10) Pub. No.: US 2018/0077532 A1
(43) Pub. Date: Mar. 15, 2018

(54) ARRANGEMENT FOR, AND METHOD OF, LOCATING AND TRACKING A MOBILE TARGET WITH IMPROVED PERFORMANCE IN A VENUE

(71) Applicant: Symbol Technologies, LLC, Lincolnshire, IL (US)

(72) Inventor: Thomas E. Wulff, Brookhaven, NY (US)

(21) Appl. No.: 15/260,968

(22) Filed: Sep. 9, 2016

(51) Int. Cl. H04W 4/02; H04W 4/04; H04B 5/00; G01C 21/20; G06Q 10/08

(52) U.S. Cl. CPC H04W 4/028; H04W 4/043; G06Q 10/087; G01C 21/206; H04B 5/0062

(57) ABSTRACT

Multiple target sensing stations are deployed overhead in a venue. A controller actuates one or more initial stations for locating, tracking, and determining a predicted route for, a mobile target, and then actuates one or more subsequent stations downstream of the predicted route prior to arrival of the mobile target to ready the subsequent stations to continue to locate and track the mobile target upon its subsequent arrival. The controller also deactuates one or more other stations that are remote from the predicted route to optimize the overall locating and tracking performance.

### BACKGROUND OF THE INVENTION

The present disclosure relates generally to an arrangement for, and a method of, locating and tracking a mobile target in a venue in which target sensing systems are deployed, and, more particularly, to optimizing the overall locating and tracking performance of the target sensing systems along a predicted route of the mobile target.

It is known to deploy a radio frequency (RF) identification (RFID) system in a retail, factory, or warehouse environment, or a like venue, for product locationing, product tracking, product identification, and inventory control. For example, in order to take an inventory of movable products associated with mobile targets, such as RFID tags, in a warehouse environment or venue, it is known to position a multitude of RFID tag readers at overhead locations in the venue, and then, to operate each such reader, under the control of a network host computer or server, to form and steer an interrogation beam over a coverage range across any such tags to read their payloads. A specific location of any particular RFID-tagged product in the venue is typically determined by having the server process the payloads and capture data from a plurality of the readers by using triangulation/trilateration techniques known in the art.

It is also known to deploy an ultrasonic locationing system in the venue to capture data from, and determine the location of, mobile targets or devices, such as handheld RFID tag readers, handheld bar code symbol readers, phones, radios, watches, tablets, or computers, that are carried and/or worn by people movable within the venue. The mobile devices can also be product movers, such as trucks, forklifts, or shopping carts, movable within the venue, for moving the products. For example, it is known to position a multitude of ultrasonic transmitters, e.g., speakers, virtually anywhere, preferably at overhead locations in the venue, and to drive the speakers, under the control of the network server, to determine the location of any such mobile device that contains an ultrasonic receiver, e.g., a microphone. Each ultrasonic speaker transmits an audio signal or ultrasonic energy in a short burst which is received by the microphone on the mobile device, thereby establishing the presence and specific location of each mobile device within the venue, again using triangulation/trilateration techniques known in the art.

It is still further known to deploy a video or surveillance system in the venue by positioning a multitude of video cameras throughout the venue. Each video camera is operated, under the control of the network server, to capture a video stream of images of mobile targets in its imaging field of view. The mobile targets can be the aforementioned RFID-tagged products, and/or the RFID-tagged product movers for moving the RFID-tagged products, and/or the aforementioned mobile devices, and/or can even be people in the venue, such as employees, shoppers or customers, under surveillance by the cameras. The people may be carrying the aforementioned RFID-tagged products, and/or the aforementioned mobile devices, and/or may be operating the aforementioned product movers or mobile devices, and/or may be wearing RFID-tagged identification badges.

Although the known RFID, ultrasonic locationing, and video systems have all been generally satisfactory for their intended purposes, the performance of the RFID system at a venue could sometimes suffer and degrade due to RF interference among the multitude of RFID tag readers deployed at the same venue, all competing for the same RF spectrum. Likewise, the performance of the ultrasonic locationing system at a venue could sometimes suffer and degrade due to acoustic interference among the multitude of ultrasonic speakers deployed at the same venue, all transmitting substantially simultaneously. Such RF and acoustic interference was made especially worse in a venue where the venue had multiple zones with multiple surfaces, e.g., walls, off which the RF/ultrasonic signals were reflected and/or scattered along multiple paths, and/or absorbed. In addition, the performance of the video system at a venue could sometimes suffer and degrade due to the high bandwidth requirement for processing the video streams from the multitude of cameras deployed at the same venue, all operating substantially simultaneously.

Simultaneously operating all the multitudes of RFID readers, ultrasonic speakers, and cameras in a venue, especially one of large size, has proven to be inefficient both in terms of their electrical power consumption and in terms of their overall locating and tracking performance. In many applications, it may not be necessary or desired to locate and track mobile targets in certain zones, or to operate any or all of the target sensing systems where there is no or little activity. Indeed, operating any such target sensing systems in zones of no or little interest may be counterproductive, because their operation might cause the aforementioned interference with the operation of the target sensing systems in those zones of interest where it is desired to accurately locate and track the mobile targets.

Accordingly, it would be desirable to improve the overall locating and tracking performance of such target sensing systems, to reduce the overall power requirements of such target sensing systems, to reduce any RF and acoustic interference caused by such target sensing systems, to reduce excess bandwidth requirements required by such target sensing systems, and to optimize the overall efficiency and overall operation of such target sensing systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a broken-away, perspective view, as seen from above, of an arrangement for locating and tracking a mobile target with improved performance in a venue in which overhead target sensing stations are deployed in accordance with the present disclosure.

FIG. 2 is a block diagram of various target sensing systems that could be installed in each target sensing station depicted in FIG. 1.

FIG. 3 is a view depicting a person operating a mobile target configured as an RFID reader to read RFID tags in the venue in which the mobile target is also located and tracked by the overhead target sensing stations of FIG. 1.

FIG. 4 is a diagrammatic top plan view of a venue analogous to FIG. 1, which depicts the actuation of the overhead target sensing stations along a predicted route, and the deactuation of other overhead target sensing stations located remotely away from the predicted route.

FIGS. 5A and 5B are a part-perspective, part-plan view, which diagrammatically depicts how the performance of the target sensing stations is optimized in accordance with the present disclosure.

FIG. 6 is a flow chart of a method of locating and tracking a mobile target with improved performance in accordance with the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for locating and tracking a mobile target with improved performance in a venue. The mobile target may be animate, i.e., a person, such as an employee, a non-employee, a delivery person, a shopper, a customer, or, in general, any individual that is authorized or even unauthorized to be in the venue. The mobile target may also be inanimate, e.g., any mobile device, such as a handheld RFID tag reader, a handheld bar code symbol reader, a phone, a radio, a watch, a tablet, a computer, or, in general, any object or thing that may be carried and/or worn and/or operated by people movable within the venue. Other examples of inanimate mobile targets include product movers, such as trucks, forklifts, shopping carts, or the like, either operated by the aforementioned people or automatically. Still other examples of inanimate mobile targets include RFID tags associated with products to locate and track the products when moved either by the aforementioned people or by the aforementioned product movers. Yet another example of an inanimate mobile target includes an RFID tag associated with an identification badge worn by an authorized person to identify the person. Thus, the mobile target may be any combination of such animate and/or inanimate targets that travels in or through the venue. The venue may be any retail, factory, or warehouse environment, or the like, both indoors and outdoors.

The arrangement includes a plurality of actuatable, target sensing stations that are deployed in the venue at fixed, preferably overhead, known positions that are spaced apart of one another, and that are operative for locating and tracking the mobile target when the stations are actuated. A controller, e.g., a host computer or network server, is operative for at least partly actuating one or more initial stations for locating and tracking the mobile target during initial movement in the venue, and for determining a predicted route for the mobile target being located and tracked by the one or more initial stations. Advantageously, the controller determines a location, a direction, and a speed of the mobile target from the one or more initial stations, and determines the predicted route based on the determined location, the determined direction, and the determined speed of the mobile target. The controller is also operative for actuating, either sequentially or simultaneously, one or more subsequent stations that are downstream of the predicted route prior to arrival of the mobile target to ready each such subsequent station to continue to locate and track the mobile target upon subsequent arrival at each such subsequent station. The controller is further operative for at least partly deactuating one or more other stations that are remote from the predicted route to optimize the locating and tracking performance of the arrangement.

In a preferred embodiment, each station includes a video system for capturing a video stream of images of a person constituting the mobile target when actuated, and/or a radio frequency (RF) identification (RFID) system for reading an RFID tag constituting the mobile target in a reading mode of operation with a set of reading parameters when actuated, and/or a locationing system for ultrasonically locating a device constituting the mobile target in a locationing mode of operation with a set of locationing parameters when actuated. Any one, or any two or more, of such systems may be operated for locating and tracking the mobile target when actuated. Advantageously, the controller changes at least one of the reading parameters upon station deactuation. The reading parameters may include a dwell time of an RF interrogation signal transmitted by the RFID system, and/or a transmit power at which the RF signal is transmitted, and/or a transmit direction along which the RF signal is transmitted, and/or a firing order of a plurality of RF signals that are transmitted by the RFID system. Furthermore, the controller changes at least one of the locationing parameters upon station deactuation. The locationing parameters may include a transmit time of an ultrasonic signal transmitted by the locationing system, and/or a transmit power at which the ultrasonic signal is transmitted, and/or a transmit direction along which the ultrasonic signal is transmitted, and/or a drive order of a plurality of ultrasonic signals that are transmitted by the locationing system.

A further aspect of this disclosure is directed to a method of locating and tracking a mobile target with improved performance in a venue. The method is performed by deploying a plurality of actuatable, target sensing stations in the venue at fixed, known positions that are spaced apart of one another, by at least partly actuating one or more initial stations for locating and tracking the mobile target during initial movement in the venue, by determining a predicted route for the mobile target being located and tracked by the one or more initial stations, by actuating one or more subsequent stations that are downstream of the predicted route prior to arrival of the mobile target to ready the one or more subsequent stations to continue to locate and track the mobile target upon subsequent arrival at the one or more subsequent stations, and by at least partly deactuating one or more other stations that are remote from the predicted route to optimize the locating and tracking performance of the arrangement.

In accordance with this disclosure, only the target sensing stations along the predicted route are actuated, while those other stations that are remote from the predicted route are not actuated. This improves the overall locating and tracking performance of such target sensing systems, reduces the overall power consumption requirements of such target sensing systems, reduces any RF and acoustic interference caused by such target sensing systems, reduces excess bandwidth requirements required by such target sensing systems, and optimizes the overall efficiency and overall operation of such target sensing systems.

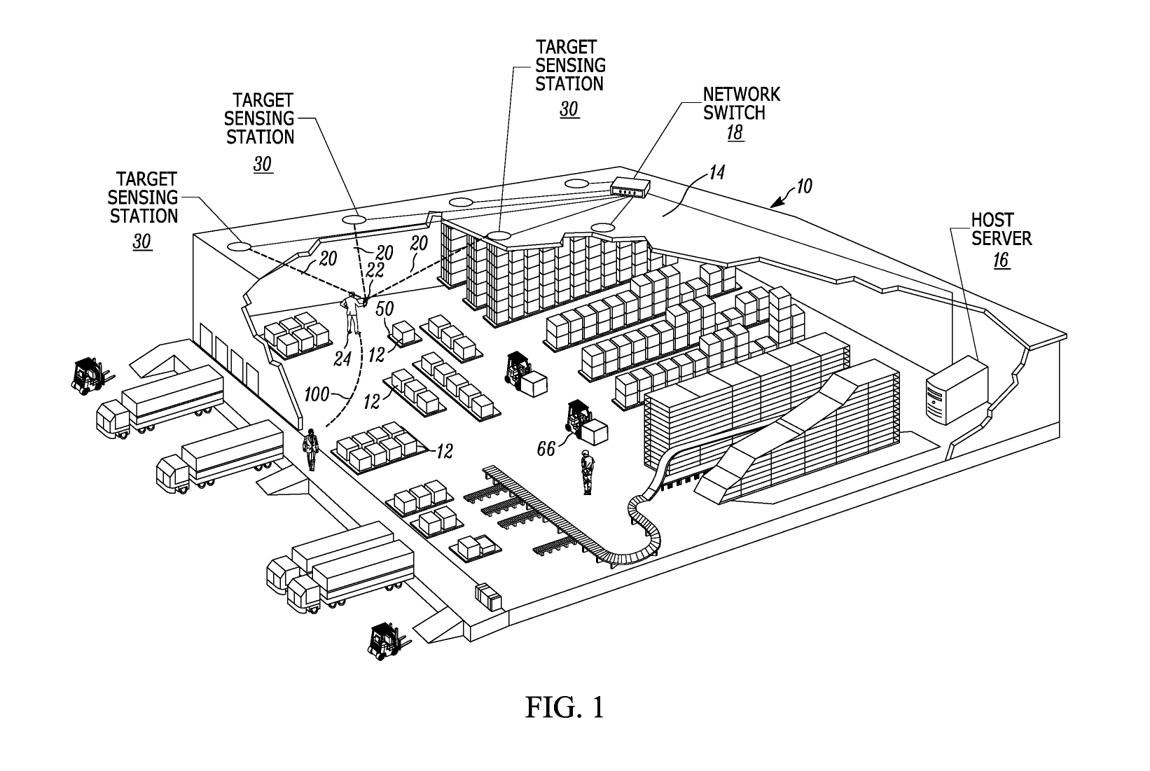

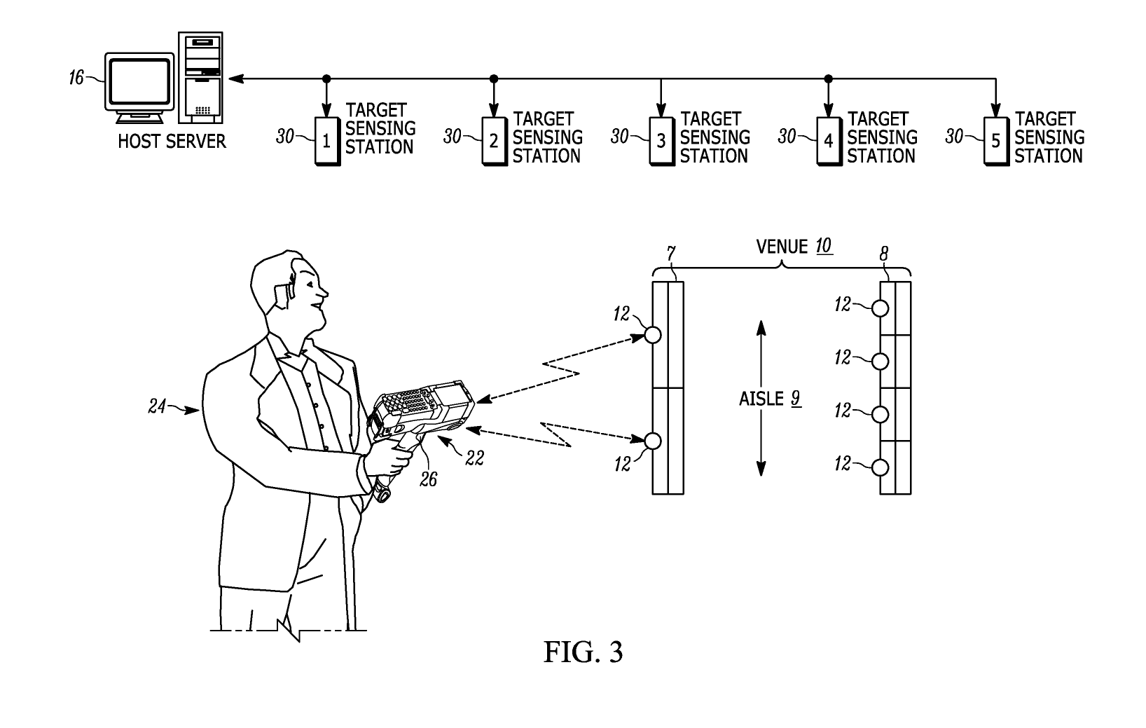

Turning now to the drawings, reference numeral 10 in FIG. 1 generally depicts a warehouse environment or a like venue in which movable products 12, shown in FIG. 1 as cuboid cartons for simplicity, may be accurately located and tracked in accordance with this disclosure. The venue 10 may be any indoor or outdoor venue, and may have any layout or configuration. As shown in FIG. 3, the venue 10 may have, for example, a plurality of shelving structures 7 and 8 separated by an aisle 9 in the venue 10, and some of the products 12 can be mounted on the shelving structure 7, and others of the products 12 can be mounted on the shelving structure 8. Each product 12 is preferably tagged with a mobile target, such as a radio frequency (RF) identification (RFID) product tag, preferably a passive RFID tag for cost reasons, and, in some applications, each RFID product tag may be associated with a pallet 50 (see FIG. 1), or a container, for supporting multiple products 12.

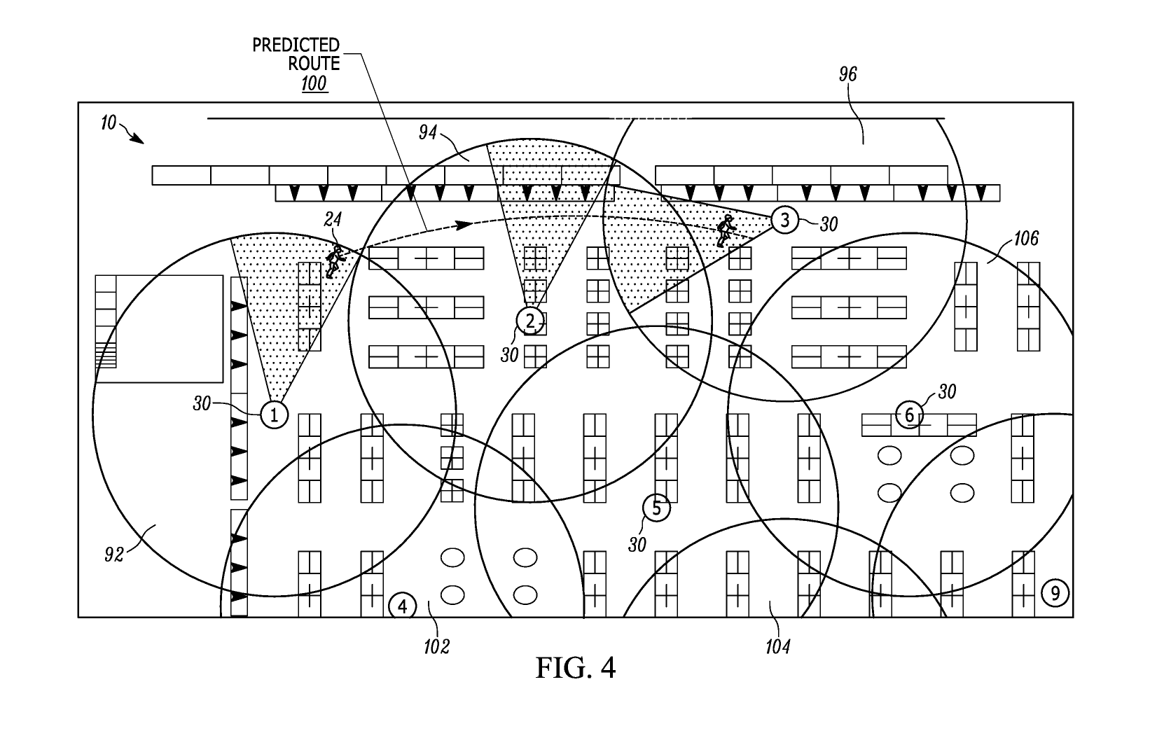

As also shown in FIG. 1, a multitude of target sensing units or stations 30 is deployed in the venue 10, and each station 30 is stationarily and fixedly mounted at known overhead positions, for example, on, or adjacent to, a ceiling 14. Advantageously, as shown in the overhead view of FIG. 4, the target sensing stations 30 can be installed every twenty to eighty feet or so apart in a grid pattern. Depending on the size of the venue, there can be, for example, thirty, sixty, or ninety or more stations 30 deployed in the venue. A network computer or host server 16, typically locally located in a backroom at the venue 10, comprises one or more computers and is in wired, wireless, direct, or networked communication with each station 30 through a network switch 18. The server 16 may also be remotely hosted in a cloud server. The server 16 may include a wireless RF transceiver that communicates with each station 30. For example, Wireless Fidelity (Wi-Fi) and Bluetooth® are open wireless standards for exchanging data between electronic devices. The server or controller 16 controls each station 30.

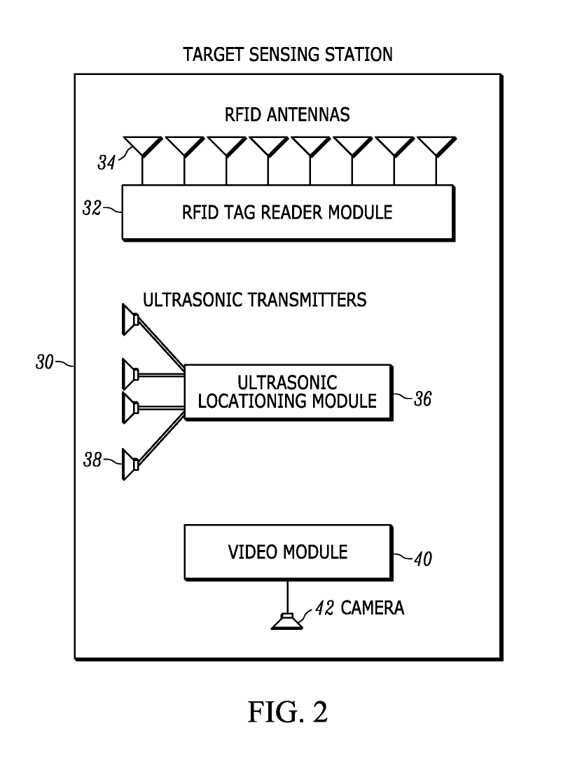

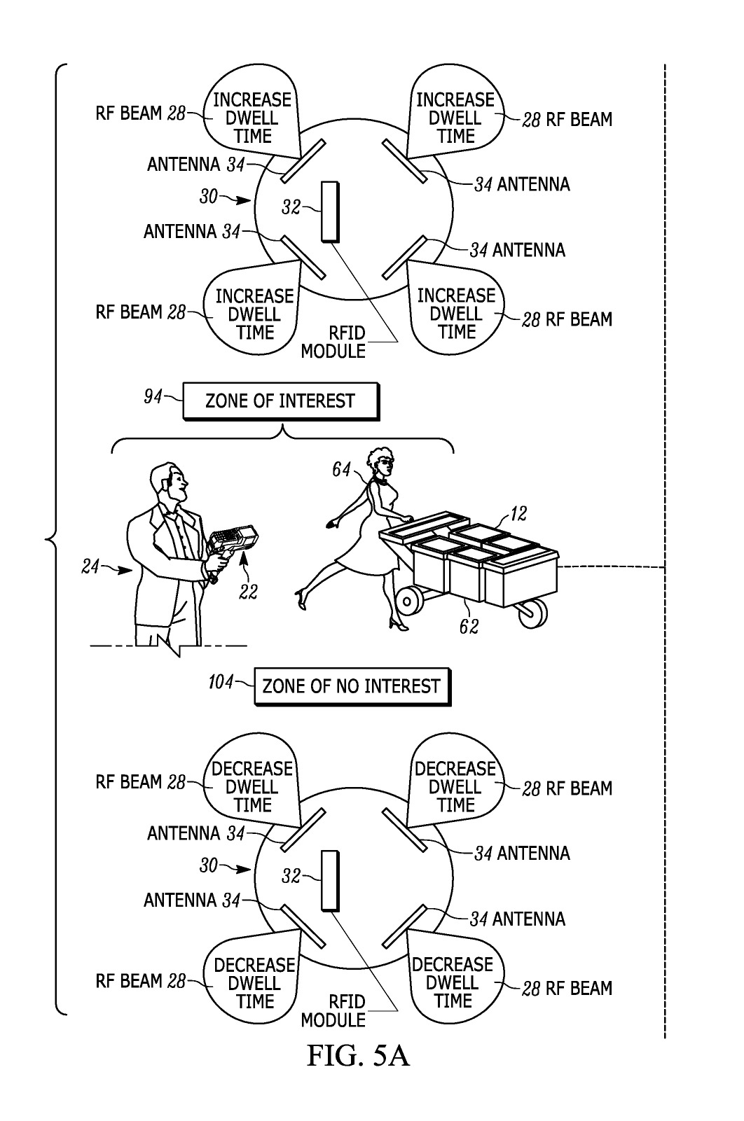

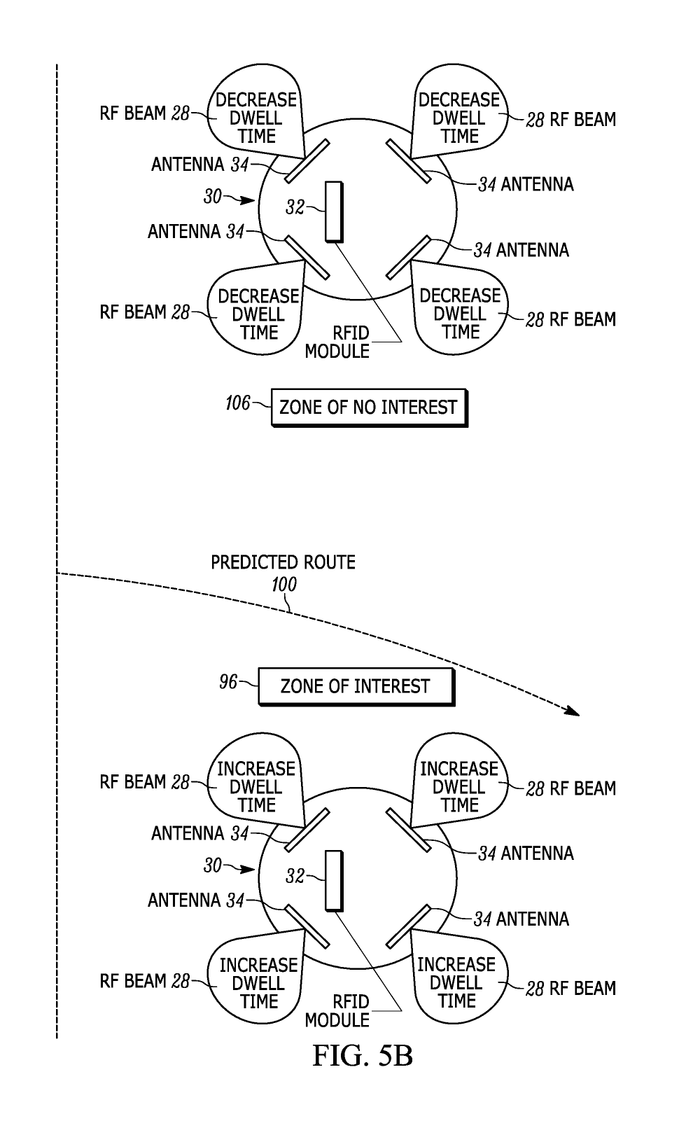

The block diagram of FIG. 2 depicts various target sensing systems that can be mounted in each overhead station 30. One of these sensing systems is a radio frequency (RF) identification (RFID) tag reader operative for reading a mobile target configured as an RFID tag as it moves along a plurality of coverage ranges or reading zones 92, 94, 96 (see FIG. 4). More particularly, as shown in FIG. 2, each overhead RFID reader includes an RFID tag reader module 32 that has a controller, a memory, and an RF transceiver, which are operatively connected to a plurality of RFID antenna elements 34, which are energized by the RFID module 32 to radiate an RF beam 28 (see FIGS. 5A, 5B) over an antenna field pattern. The RF transceiver is operated, under the control of the tag reader module 32, to transmit RF beams 28 to the tags, and to receive RF response signals from, the tags, thereby interrogating and processing the payloads of the tags that are in its reading zone 92, 94, 96. The payload or captured target data identifies the tags and their associated products 12. As shown in FIG. 3, the server 16 controls the overhead RFID readers in the plurality of target sensing stations 30, also identified by the numerals 1-5, to read the tags on the products 12 in a reading mode of operation in accordance with a set of reading parameters, as described below.

As further shown in FIGS. 1 and 3, a person 24 holds, carries, and operates any of the aforementioned mobile devices such as, a mobile phone, or as illustrated by way of non-limiting example, a handheld, portable, mobile RFID tag reader 22 during his/her movement along a route 100 identified by dashed lines in FIG. 1 within the venue 10. As described below, the person 24 himself/herself and/or the tag reader 22, may each be considered, either individually or jointly, as a mobile target to be located and tracked in the venue. The mobile reader 22 has a controller, a memory, and an RF transceiver operatively connected to an RFID antenna, which are together operative for reading the product tags associated with the products 12 in the venue 10 during travel across the reading zones 92, 94, 96, as described below. The person 24 may be any individual, employee, operator, or associate authorized to operate the handheld, mobile reader 22. To initiate reading, the person 24 manually actuates an actuator or trigger 26 on the mobile reader 22. More than one mobile reader 22 may be present and movable in the venue 10.

Another target sensing system that can be mounted in each overhead station 30 is, as shown in FIG. 2, an ultrasonic locationing system operative for locating, for example, a phone, a mobile device, or by way of non-limiting example, the mobile reader 22, by transmitting an ultrasonic signal to an ultrasonic receiver, e.g., a microphone, on the mobile reader 22 or phone. More particularly, the locationing system includes an ultrasonic locationing module 36 having control and processing electronics operatively connected to a plurality of ultrasonic transmitters, such as voice coil or piezoelectric speakers 38, for transmitting ultrasonic energy to the microphone on the mobile reader 22. The receipt of the ultrasonic energy at the microphone locates the mobile reader 22. Each ultrasonic speaker 38 periodically transmits ultrasonic ranging signals, preferably in short bursts or ultrasonic pulses, which are received by the microphone on the mobile reader 22. The microphone determines when the ultrasonic ranging signals are received. The locationing module 36, under the control of the server 16, directs all the speakers 38 to emit the ultrasonic ranging signals such that the microphone on the mobile reader 22 will receive minimized overlapping ranging signals from the different speakers 38. The flight time difference between the transmit time that each ranging signal is transmitted and the receive time that each ranging signal is received, together with the known speed of each ranging signal, as well as the known and fixed locations and positions of the speakers 38 on each sensing station 30, are all used to determine the position of the microphone and of the mobile reader 22, using a suitable locationing technique, such as triangulation, trilateration, multilateration, etc, as diagrammatically shown by dashed lines 20 in FIG. 1.

Yet another sensing system that could be used to locate a mobile target, especially the person 24, is a video system operative for locating the person 24 by capturing an image of the person 24. More particularly, the video system is mounted in each sensing station 30 and includes a video module 40 having camera control and processing electronics that is connected to a camera 42 for capturing the image of the person 24. The camera 42 is advantageously a high-bandwidth, moving picture expert group (MPEG) compression camera. The capture of the image by the camera 42 is processed by the server 16 to locate the person 24.

Other non-illustrated sensing systems that could be used to locate a mobile target is a Wireless Fidelity (Wi-Fi) system operative for locating the mobile target by transmitting multiple Wi-Fi signals to a Wi-Fi receiver in the mobile target. More particularly, the Wi-Fi system is mounted in each sensing station 30 and includes a Wi-Fi network module having control and processing electronics operatively connected to a Wi-Fi antenna. Each Wi-Fi signal is transmitted to the Wi-Fi receiver in the mobile target. The receipt of multiple Wi-Fi signals from multiple Wi-Fi systems at the Wi-Fi receiver locates the mobile target. Still another non-illustrated sensing system that could be used to locate a mobile target is a Bluetooth Low Energy (BLE) system for locating the mobile target by transmitting multiple BLE signals to a BLE receiver in the mobile target. More particularly, the BLE system is mounted in each sensing station 30 and includes a BLE network module having control and processing electronics operatively connected to a BLE antenna. Each BLE signal is transmitted to the BLE receiver in the mobile target. The receipt of multiple BLE signals from multiple BLE systems at the BLE receiver locates the mobile target.

The illustrated target sensing systems in each station 30 can be mounted in a common housing and operated, either individually or jointly, to sense a variety of mobile targets. For example, each video system 40, 42 can capture video streams of images of animated targets, such as the authorized person or employee 24, but can also locate and track such other animated targets as non-employees, delivery personnel, shoppers 64 (see FIGS. 5A, 5B), customers, or, in general, any individual that is authorized or even unauthorized to be in the venue 10. The RFID system 32, 34 can locate and track inanimate targets, such as RFID tags, associated with the products 12, the pallets 50, product movers such as shopping carts 62 (see FIGS. 5A, 5B) or forklifts 66 (see FIG. 1), or even RFID-tagged identification badges worn by the people 24. The ultrasonic locationing system 36, 38 can locate and track not only the aforementioned handheld RFID tag reader 22, but also such other inanimate targets as handheld bar code symbol readers, phones, radios, watches, tablets, computers, or, in general, any device, object or thing that includes a receiver and that may be carried and/or worn and/or operated by people movable within the venue.

In accordance with this disclosure, the host server or controller 16 is operative for at least partly, or fully, actuating one or more initial stations 30, for example, stations 1 and 2 in FIGS. 3-4, for locating and tracking the mobile target (as illustrated, the person 24) during initial movement in the venue 10, and for determining a predicted route 100 for the mobile target 24. Station 1 is located in zone 92, and station 2 is located in zone 94. Advantageously, the controller 16 determines a location, a direction, and a speed of the mobile target 24 from the initial stations 1 and 2. The fixed positions of, and the distance between, the stations 1 and 2 are known, and the time taken for the mobile target 24 to travel between these stations 1 and 2 is measured by the controller 16 and used to determine the speed.

The controller 16 is also operative for actuating, either sequentially or simultaneously, one or more subsequent stations, for example, station 3 located in zone 96 in FIG. 4, that are downstream of the predicted route 100 prior to arrival of the mobile target 24 to ready each such subsequent station 3 to continue to locate and track the mobile target 24 upon subsequent arrival at each such subsequent station 3. The controller 16 is further operative for at least partly, or fully, deactuating one or more other stations, such as stations 4, 5 and 6 in FIG. 4, that are remote from the predicted route 100 to optimize the locating and tracking performance of the arrangement. Stations 4, 5 and 6 are located in zones 102, 104, and 106 and are sometimes referred to herein as idle or non-busy zones of little or no interest, because the predicted route 100 does not pass through these zones and there is little or no activity or movement therein. Stations 1, 2 and 3 located in zones 92, 94, and 96 are sometimes referred to herein as busy zones of interest, because the predicted route 100 does pass through these zones and there is activity and movement therein.

Thus, only the target sensing stations 1, 2 and 3 along the predicted route 100 are actuated, while the remote stations 4, 5 and 6 are not actuated. As described above, this improves the overall locating and tracking performance of the target sensing systems, reduces the overall power requirements of the target sensing systems, reduces any RF and acoustic interference caused by the target sensing systems, reduces excess bandwidth requirements required by the target sensing systems, and optimizes the overall efficiency and overall operation of the target sensing systems.

FIGS. 5A and 5B together depict various exemplary mobile targets, e.g., the person 24 operating the mobile reader 22, or the shopper 64 pushing the cart 62 in which RFID-tagged products 12 are being transported, during movement between the busy zones 94, 96 of interest along the predicted route 100. Alternately, or in addition, the person 24 or the shopper 64 may each be carrying a phone having a microphone whose position is located and tracked by the ultrasonic locationing system. At these busy zones 94, 96, the stations 30 are at least partly, and preferably fully, operating at full performance, to locate and track at least one of these targets. For example, the illustrated RFID system 32, 34 in each station reads the RFID tags in a reading mode of operation with a set of reading parameters or settings. One such reading parameter is the duration of a dwell time of an RF interrogation signal transmitted by the RFID system. The dwell time is the length of time that an RFID tag stays in the field 28 of the RF interrogation beam. The controller 16 increases the dwell time, or changes any other reading parameter in order to insure that the mobile target is accurately located and tracked. Other reading parameters that can be changed include, but are not limited to, a transmit power at which the RF signal is transmitted, and/or a transmit direction along which the RF signal is transmitted, and/or a firing order of a plurality of RF signals that are transmitted by the RFID antennas 34. The transmit power can be increased in the busy zones 94, 96. The transmit direction can point toward the predicted route 100. The firing order can favor those antennas 34 facing the predicted route 100. Any one or more of such reading parameters can be varied in any combination.

By contrast, at the idle zones 104, 106, the stations 30 that are remote from the predicted route 100 are at least partly, and preferably fully, deactuated, because there is no need to locate and track the non-existent mobile target. Thus, the controller 16 decreases the dwell time, or changes any other reading parameter in order to insure that the mobile target is not located and tracked. Analogously, the transmit power can be decreased in the idle zones 104, 106. The transmit direction need not point toward the predicted route 100. The firing order need not favor those antennas 34 facing the predicted route 100.

Analogously, the locationing system locates the mobile devices in a locationing mode of operation with a set of locationing parameters or settings. One such locationing parameter is the duration of a transmit time of an ultrasonic signal transmitted by the locationing system. The transmit time is the length of time that a mobile device is located in the presence of the ultrasonic signal. The controller 16 increases the transmit time, or changes any other locationing parameter or setting, in order to insure that the mobile device is accurately located and tracked. Thus, at busy zones 94, 96, the controller 16 increases the transmit time. Other locationing parameters that can be changed include, but are not limited to, a transmit power at which the ultrasonic signal is transmitted, and/or a transmit direction along which the ultrasonic signal is transmitted, and/or a drive order of a plurality of ultrasonic signals that are transmitted by a plurality of ultrasonic speakers 56. The transmit power can be increased in the busy zones 94, 96. The transmit direction can point toward the predicted route 100. The firing order can favor those speakers 38 facing the predicted route 100. Any one or more of such locationing parameters can be varied in any combination. At the idle zones 104, 106, the stations 30 that are remote from the predicted route 100 are at least partly, and preferably fully, deactuated, because there is no need to locate and track the non-existent mobile device.

The RFID, locationing, and video systems need not be independently operative of each other, but could mutually cooperate with other to accurately locate and track the targets. For example, the RFID system may determine the general location or neighborhood of the target with a certain level of accuracy, and the locationing system may determine the location of the target with a higher or finer level of accuracy.

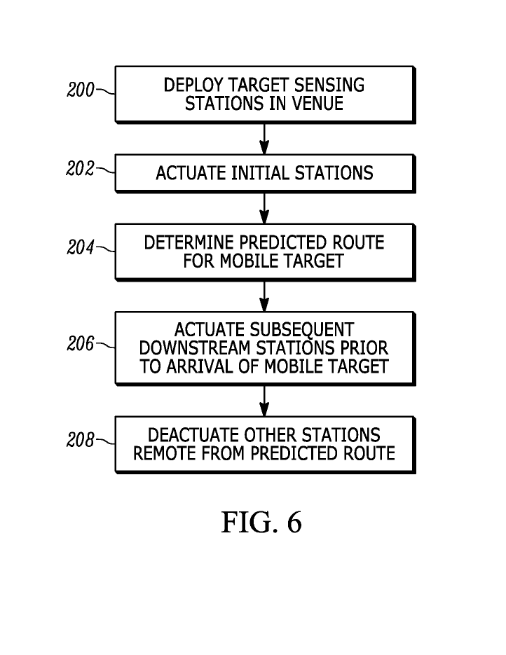

The flow chart of FIG. 6 depicts the operation of the method of this disclosure. In step 200, the method is performed by deploying a plurality of actuatable, target sensing stations 30 in the venue 10 at fixed, known positions that are spaced apart of one another. In step 202, one or more initial stations are actuated for locating and tracking the mobile target during initial movement in the venue 10. In step 204, the controller 16 determines a predicted route 100 for the mobile target being located and tracked by the one or more initial stations. In step 206, one or more subsequent stations that are downstream of the predicted route 100 are actuated prior to the arrival of the mobile target to ready the one or more subsequent stations to continue to locate and track the mobile target upon subsequent arrival at the one or more subsequent stations. In step 208, one or more other stations that are remote from the predicted route are deactuated to optimize the locating and tracking performance of the arrangement.

In summary, when a mobile target is traveling along a path or the route 100 within the venue 10, the relevant overhead target sensing stations 30 along the route 100 will automatically turn on to ensure that each such station 30 is fully functional prior to the arrival of the mobile target in motion. At the same time, the other stations 30 that are remote from the route 100 are shut down.

In an advantageous application involving RFID tags, such tags have an A-state and a B-state. When unpowered, the tags are usually in the A-state. Actuating an RFID system flips the tags to the B-state. When a new tag (in the A-state) enters the coverage zone of an actuated RFID system, the tag is read. If all the tags were in the A-state, then the new tag (in the A-state) entering the coverage zone of an actuated RFID system would not have been read. However, in accordance with this disclosure, the overhead RFID system would have been turned on prior to the arrival of the new tag, and, as a result, all the tags would have already been flipped to the B-state, in which case, the new tag in the A-state would be readily recognized and read. In another advantageous application involving the ultrasonic locationing system, it is desirable to have several ultrasonic speakers surrounding the route 100 always actuated so that the target can be located by trilateration.

The arrangement disclosed herein is particularly well suited for order fulfillment operations, where an operator 24 walks through the venue 10 along the route 100 with a picklist, and the operator is tasked with picking the products 12 on the picklist to complete a customer's order. By only automatically turning on the relevant overhead target sensing stations 30 along the route 100, and by ensuring that each such station 30 along the route 100 is fully functional prior to the arrival of the operator 24, the picklist procedure can be completed efficiently and expeditiously.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for locating and tracking a mobile target with improved performance in a venue, the arrangement comprising:
a plurality of actuatable, target sensing stations deployed in the venue at fixed, known positions that are spaced apart of one another, and operative for locating and tracking the mobile target when the stations are actuated; and
a controller for at least partly actuating at least an initial one of the stations for locating and tracking the mobile target during initial movement in the venue, for determining a predicted route for the mobile target being located and tracked by the at least initial one of the stations, for actuating at least a subsequent one of the stations that is downstream of the predicted route prior to arrival of the mobile target to ready the at least one subsequent one of the stations to continue to locate and track the mobile target upon subsequent arrival at the at least one subsequent one of the stations, and for at least partly deactuating at least another one of the stations that is remote from the predicted route to optimize the locating and tracking performance of the arrangement.

2. The arrangement of claim 1, wherein each station includes at least one of a video system for capturing a video stream of images of a person constituting the mobile target when actuated, a radio frequency (RF) identification (RFID) system for reading an RFID tag constituting the mobile target in a reading mode of operation with a set of reading parameters when actuated, and a locationing system for ultrasonically locating a device constituting the mobile target in a locationing mode of operation with a set of locationing parameters when actuated.

3. The arrangement of claim 2, wherein each station has a housing in which the RFID system, the locationing system, and the video system are all supported, and wherein each housing is fixedly mounted overhead in the venue.

4. The arrangement of claim 2, wherein a plurality of the systems in each station is operative for locating and tracking the mobile target when actuated.

5. The arrangement of claim 2, wherein the controller determines a location, a direction, and a speed of the mobile target from the at least initial one of the stations, and determines the predicted route based on the determined location, the determined direction, and the determined speed of the mobile target.

6. The arrangement of claim 2, wherein the controller changes at least one of the reading parameters upon station deactuation, and wherein the reading parameters include at least one of a dwell time of an RF interrogation signal transmitted by the RFID system, a transmit power at which the RF signal is transmitted, a transmit direction along which the RF signal is transmitted, and a firing order of a plurality of RF signals that are transmitted by the RFID system.

7. The arrangement of claim 2, wherein the controller changes at least one of the locationing parameters upon station deactuation, and wherein the locationing parameters include at least one of a transmit time of an ultrasonic signal transmitted by the locationing system, a transmit power at which the ultrasonic signal is transmitted, a transmit direction along which the ultrasonic signal is transmitted, and a drive order of a plurality of ultrasonic signals that are transmitted by the locationing system.

8. The arrangement of claim 1, wherein the controller is operative for sequentially actuating the stations along the predicted route.

9. The arrangement of claim 1, wherein the controller is operative for simultaneously actuating the stations along the predicted route.

10. A method of locating and tracking a mobile target with improved performance in a venue, the method comprising:
deploying a plurality of actuatable, target sensing stations in the venue at fixed, known positions that are spaced apart of one another;
at least partly actuating at least an initial one of the stations for locating and tracking the mobile target during initial movement in the venue;
determining a predicted route for the mobile target being located and tracked by the at least initial one of the stations;
actuating at least a subsequent one of the stations that is downstream of the predicted route prior to arrival of the mobile target to ready the at least one subsequent one of the stations to continue to locate and track the mobile target upon subsequent arrival at the at least one subsequent one of the stations; and
at least partly deactuating at least another one of the stations that is remote from the predicted route to optimize the locating and tracking performance of the arrangement.

11. The method of claim 10, and configuring each station with at least one of a video system for capturing a video stream of images of a person constituting the mobile target when actuated, a radio frequency (RF) identification (RFID) system for reading an RFID tag constituting the mobile target in a reading mode of operation with a set of reading parameters when actuated, and a locationing system for ultrasonically locating a device constituting the mobile target in a locationing mode of operation with a set of locationing parameters when actuated.

12. The method of claim 11, and supporting the RFID system, the locationing system, and the video system in each station in a housing, and fixedly mounting each housing overhead in the venue.

13. The method of claim 11, and locating and tracking the mobile target with a plurality of the systems in each station when actuated.

14. The method of claim 11, wherein the determining of the predicted route is performed by determining a location, a direction, and a speed of the mobile target from the at least initial one of the stations.

15. The method of claim 11, and changing at least one of the reading parameters upon station deactuation, and configuring the reading parameters to include at least one of a dwell time of an RF interrogation signal transmitted by the RFID system, a transmit power at which the RF signal is transmitted, a transmit direction along which the RF signal is transmitted, and a firing order of a plurality of RF signals that are transmitted by the RFID system.

16. The method of claim 11, and changing at least one of the locationing parameters upon station deactuation, and configuring the locationing parameters to include at least one of a transmit time of an ultrasonic signal transmitted by the locationing system, a transmit power at which the ultrasonic signal is transmitted, a transmit direction along which the ultrasonic signal is transmitted, and a drive order of a plurality of ultrasonic signals that are transmitted by the locationing system.

17. The method of claim 10, and sequentially actuating the stations along the predicted route.

18. The method of claim 10, and simultaneously actuating the stations along the predicted route.
